(19) United States
(12) Patent Application Publication
(10) Pub. No.: US 2011/0108389 A1
(43) Pub. Date: May 12, 2011

(54) CANS OR BOTTLES ORIENTATOR

(75) Inventor: Jean Christophe Bonnain, Chateauroux (FR)

(73) Assignee: Mead Westvaco Packaging Systems ,LLC, Raleigh, NC (US)

(21) Appl. No.: 12/988,025

(22) PCT Filed: Apr. 16, 2009
(86) PCT No.: PCT/US2009/040825

§ 371 Date: Dec. 21, 2010

(30) Foreign Application Priority Data
Apr. 16, 2008 (GB) 08/068843

(51) Int. Cl. B65G 47/244; B65G 47/84

(52) U.S. Cl. 198/384

(57) ABSTRACT

Apparatus (150) for orientating articles A comprising a transfer mechanism (114) for transferring articles at a transfer speed, a sensor for determining the orientation of an article being transferred, an article orientation mechanism (112) moveable at a second speed different to said transfer speed and an engagement mechanism operable to selectively engage an article with the article orientation mechanism in response to information collected by the sensor wherein the article is moved to a desired orientation.

### FIELD OF THE INVENTION

The invention relates to a packaging machine and a method of packaging articles. More specifically, but not exclusively, the invention relates to a device for orientating articles and method thereof.

### BACKGROUND OF THE INVENTION

In the field of packaging it is often required to provide consumers with secondary packages comprising one or more articles, such articles may be primary packages and may be arranged in a group and secured together by means of a carton or other suitable packaging. When such carton or packaging allows the packaged articles to be viewed in situ it is often desirable to orient the packaged articles with respect one another and/or the carton or packaging. In doing so it may be desirable to orient the packaging such that aspects of the articles appearance are either clearly visible or alternatively are hidden from view.

U.S. Pat. No. 3,618,743 to Benatar et al discloses an article orientating device in which articles are rotated whilst engaged by a star wheel.

It is desirable to provide an article orientating device which can achieve a high throughput of articles and also a high degree of control over the orientation of the articles.

### SUMMARY OF INVENTION

According to a first aspect of the present invention there is provided an apparatus for orientating articles comprising a transfer mechanism for transferring articles at a first speed, at least one sensor for determining the orientation of an article being transferred, an article orientation mechanism moveable at a second speed different from said first speed and an engagement mechanism operable to selectively engage an article with the article orientation mechanism when a desired orientation of the article has been achieved.

Preferably, the apparatus comprises a single drive mechanism coupled to the article orientation mechanism.

Preferably, the apparatus comprises a controller which sends a signal to the engagement mechanism in response to information collected by the sensor to disengage the article orientation mechanism from the article whereby resulting in said desired orientation of the article.

Preferably, the apparatus comprises a controller which sends a signal to the article orientation mechanism instructing the article orientation mechanism to impart to the article a predetermined rotation calculated from the information collected by the sensor whereby resulting in said desired orientation of the article.

Preferably, the sensor comprises a colour sensor for detecting a predetermined sequence of colours.

Optionally, the article orientation mechanism comprises an endless belt. Optionally, the article orientation mechanism comprises a rotator for receiving each article.

Preferably, the engagement mechanism comprises a lifting mechanism for lifting an article, so as to disengage the article from the article orientation mechanism.

Preferably, the transfer mechanism comprises a starwheel having pockets for receiving an article, said starwheel being rotatably mounted about a central axis.

Preferably, the apparatus comprises a drive mechanism coupled to the transfer mechanism.

According to a second aspect of the present invention there is provided a packaging machine comprising an article orientation device as herebefore described.

According to a third aspect of the present invention there is provided a method of orientating articles comprising receiving articles in a transfer mechanism, determining the orientation of the articles, upon determining an incorrectly orientated article; engaging said incorrectly orientated article with an article orientation mechanism, moving the article until it is correctly orientated, disengaging the article orientation mechanism from the article, wherein said article orientation mechanism is moveable at a speed relative to the transfer mechanism.

Preferably, the articles are orientated whilst being transferred by the transfer mechanism.

### BRIEF DESCRIPTION OF THE DRAWINGS

Exemplary embodiments of the invention will now be described with reference to the accompanying drawings, in which:

FIG. 1 shows a plan view of a prior art device for orientating articles;

FIG. 2 shows a side view partially in and taken generally along the line designated 3-3 of the prior art device shown in FIG. 1;

FIG. 3 shows a perspective view of a device for incorporation into a packaging machine according to a first embodiment of the invention;

FIG. 4 shows a detailed perspective view of the device of FIG. 3;

FIG. 5 shows a plan view of a device for incorporation in to a packaging machine according to a second embodiment of the invention;

FIG. 6a shows a cross sectional view through line B-B′ of the device of FIG. 5 when the article is being rotated;

FIG. 6b shows a cross sectional view through line B-B′ of the device of FIG. 5 when the article is not being rotated;

FIG. 7a shows a perspective view from above of a device for incorporation into a packaging machine according to a third embodiment of the invention;

FIG. 7b shows a perspective view from below of a device for incorporation into a packaging machine according to a third embodiment of the invention;

FIG. 8a shows a plan view of the device of FIG. 7 in a first mode of operation; and

FIG. 8b shows a plan view of the device of FIG. 7 in a second mode of operation.

### DETAILED DESCRIPTION OF PREFERRED EMBODIMENT

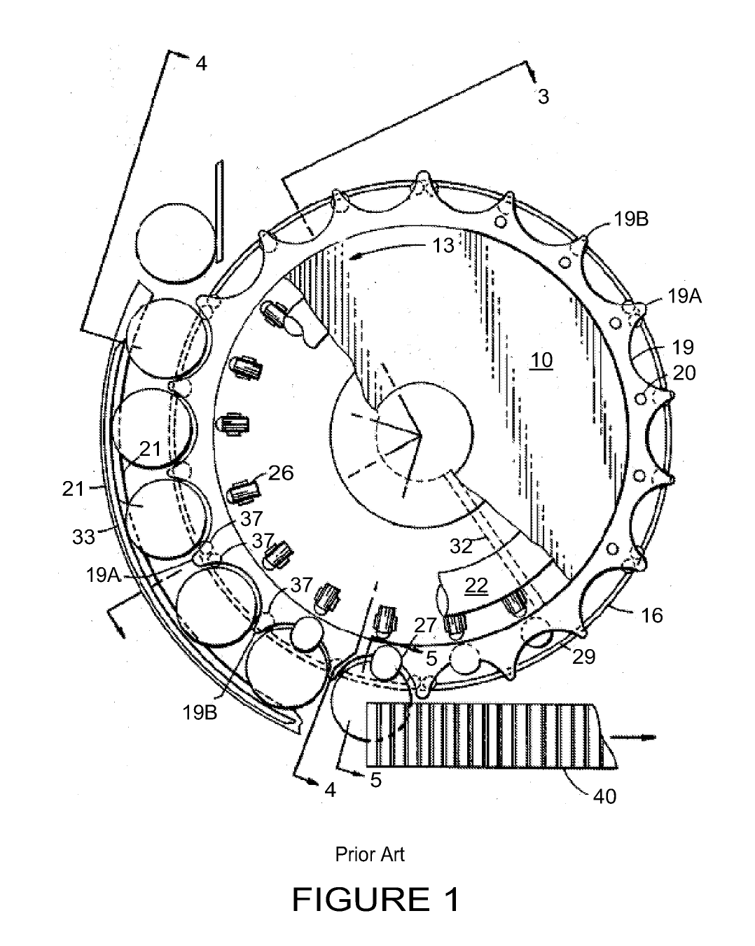

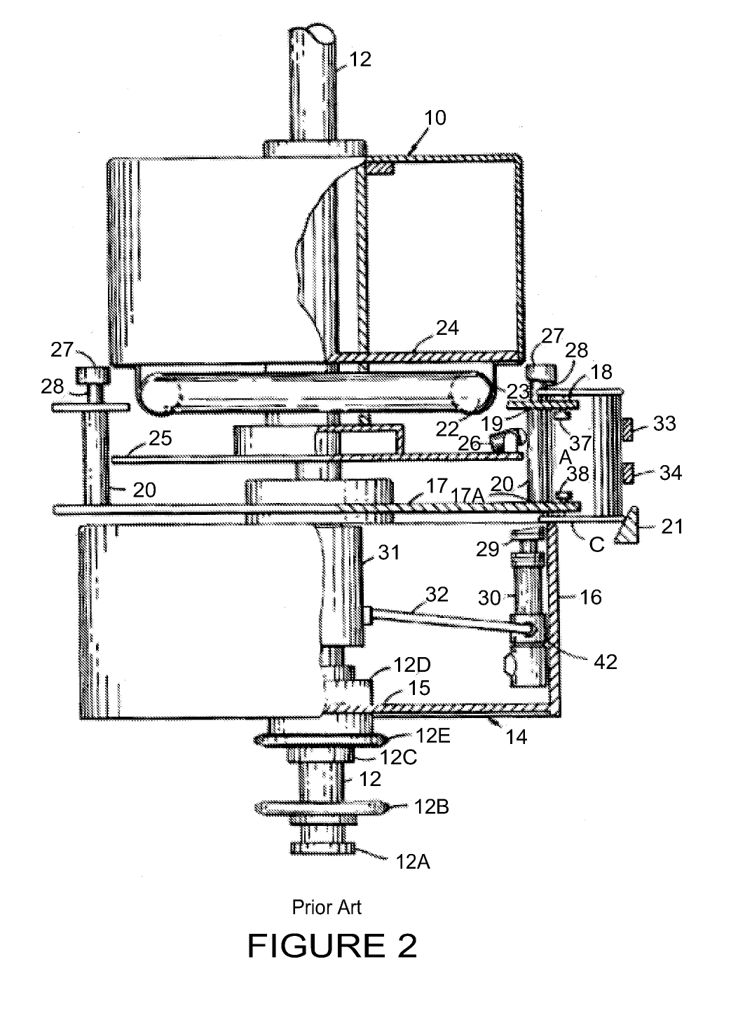

As is shown in FIGS. 1 and 2, a device 10 for orientating articles, as is known in the prior art, U.S. Pat. No. 3,618,743, comprises a vertically disposed main shaft 12. This shaft is suitably mounted in conventional bearings one of which is indicated schematically at 12A. A sprocket 12B is secured to shaft 12 whereby the shaft is rotated. As shown in FIG. 2, the shaft 12 rotates in a counterclockwise direction as indicated by the arrow 13. Referring back to FIG. 1, a sprocket 12E is affixed to bearing 12C, sprocket 12E is rotatable about shaft 12 is driven by means (not shown) at speeds greater than shaft 12. For example sprocket 12E may rotate twice as fast as shaft 12 or even faster for some applications known in the prior art.

Disposed on the shaft 12 is an article-spinning element 14 and which preferably takes the form of a plate element 15 having circular side portions 16. Bearing 12D is mounted on shaft 12 and aids in supporting spinning element 14.

As is apparent in FIG. 2, article-spinning element 14 bears a portion of the weight of article A during spinning and fixed beveled ringlike spinning element 21 also supports a portion of the weight of an article. Spinning elements 14 and 21 being relatively movable cause an article to roll around the fixed element 21. It is noteworthy that both spinning elements engage different parts of the strong bottom chime C of can A.

During spinning, articles A must be held against toppling and against undesired movement in a direction transverse to their axes of spin. Toward this end fixed guides 33 and 34 are disposed above spinning element 21 and prevent movement toward the right of articles A as is shown in FIG. 2. During spinning articles A are disposed within pockets 17A formed in starwheel 17 mounted on and rotatable with shaft 12, at a speed substantially less than spinning element 14. A similar starwheel 18 is secured to starwheel 17 by pins 20 and is provided with pockets 19 in alignment with pockets 17A. Thus starwheels 17 and 18 and their article receiving pockets together with fixed peripheral guides 33 and 34 constitute positioning means for the articles which prevents toppling of the articles and precludes undesired movement of the articles in a direction transverse to their spin axes.

For the purpose of sensing a predetermined orientation of the articles A, any suitable known device may be employed. As shown in the drawings a toroidal fluorescent-type lamp 22 is affixed by brackets 23 and a plate 24 mounted on shaft 12. Mounted about support plate 25 on shaft 12 is a plurality of phototubes 26. Thus light emanating from the fluorescent tube 22 is directed downwardly inside the ringlike starwheel element 18 and illuminates the sides of the articles A. Light is thus reflected from an article A to one of the phototubes 26. Thus a change in the reflectivity of a particular surface of article A effects a change in current through the phototube 26. This signal by known means is employed to actuate gripping means provided according to the apparatus of the prior art.

FIG. 2 shows a gripping device comprising a fixed gripping pad 27 mounted on a suitable pedestal 28 which in turn is supported on starwheel 17 together with a movable gripping pad 29 which is reciprocally moveable vertically by a cylinder and piston mechanism 30. Actuating fluid for the cylinder 30 is supplied from a suitable reservoir 31 through the tubular conduit 32 and solenoid valve 42. Thus when an appropriate signal is received by a particular phototube 26, a control action is initiated whereby a blast of fluid such as compressed air is supplied through solenoid valve 42 to cylinder 30 which imparts upward motion to gripping pad 29. When gripping pad 29 engages the bottom of the chime C of can A, the article A is elevated and is thus gripped between the pads 27 and 29.

Elevation of the article A causes the article A to disengage from the spinning element 14, 16 and the fixed high-friction spinning element 21. This action eliminates friction between the article and the spinning elements after the desired orientation is achieved and facilitates retention of the article in the desired position. This operation also eliminates stress on the article and on the device and thereby aids in the high-speed operation of the prior art machine.

During spinning the articles A are secured against outward displacement toward the right as viewed for example in FIG. 2, by means of the upper fixed peripheral positioning guide 33 and a lower fixed peripheral positioning guide 34 while positioning pockets 17A and 20 envelope and secure the articles.

After an article A is securely gripped by gripping pads 27 and 29, the article A is fixed in position against rotation about its vertical axis and hence may swing in an arc about shaft 12 as a center.

In order to facilitate rotation of an article A relative to the rotatable positioning star wheels 17 and 18, a plurality of low-friction devices 37 and 38 are mounted on the elements 17 and 18. As is best seen in FIG. 2, for example, roller 37 is mounted on and disposed underneath the starwheel ringlike positioning device 18 while the low-friction roller 38 is mounted on and disposed above the starwheel 17. As is apparent in FIG. 1 these low-friction elements are disposed at the junctions between the pockets 19. At a wide portion 19A between adjacent pockets are mounted a pair of low-friction rollers 37 whereas at a narrow junction 19B a single roller 37 is mounted. Thus it is apparent from FIG. 1 that the articles A freely rotate relative to their associated positioning pockets 19 and are not normally in contact with the positioning guides 33 and 34.

After the articles A are gripped they are maintained in fixed relation about their vertical axes and are swung in an arc about the shaft 12 to a conveyor 40. The conveyor 40 receives the articles A and carries the articles A out of the orienting device and into some other device such as a packaging machine.

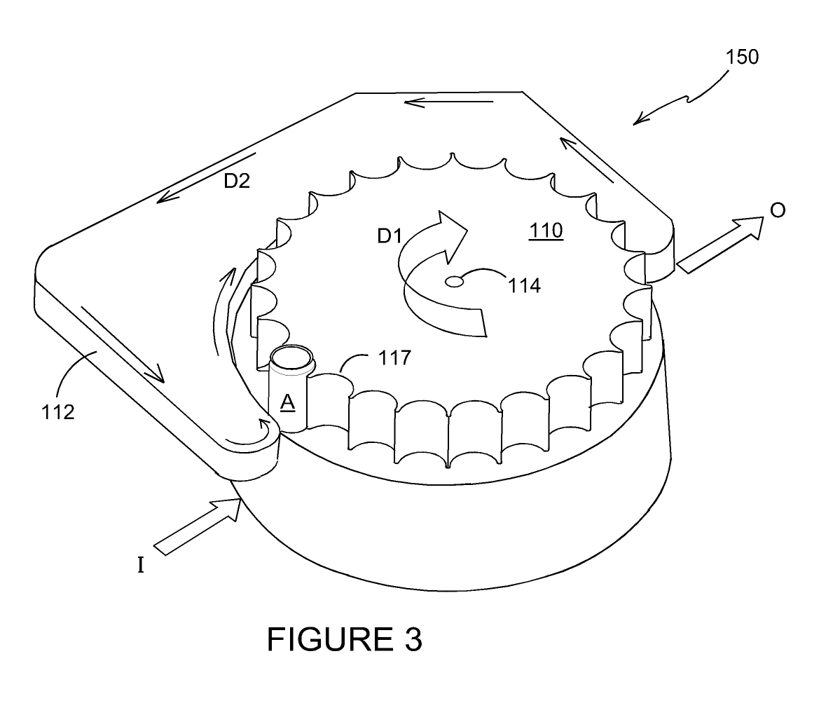

Turning now to FIG. 3 there is shown an article orientating device 150 according to an exemplary embodiment of the present invention which comprises a starwheel 110 having pockets 117 for receiving an article A. The article orientating device 150 comprises a drive means (not shown) such as a servo motor which is coupled to the starwheel 110 such that the starwheel 110 is rotatable in direction D1. The article orientating device 150 comprises a dynamic article rotation device 112 such as an endless belt which is driven in a direction D2. In the embodiment shown the starwheel 110 rotates in a clockwise direction about its central axis 114. The dynamic article rotation device 112 is driven in a counterclockwise direction; a portion of the dynamic article rotation device 112 is concentric with the starwheel 110. The dynamic article rotation device 112 is driven such that over the concentric portion the belt is travelling about the central axis 114 of the starwheel 110 in a clockwise direction.

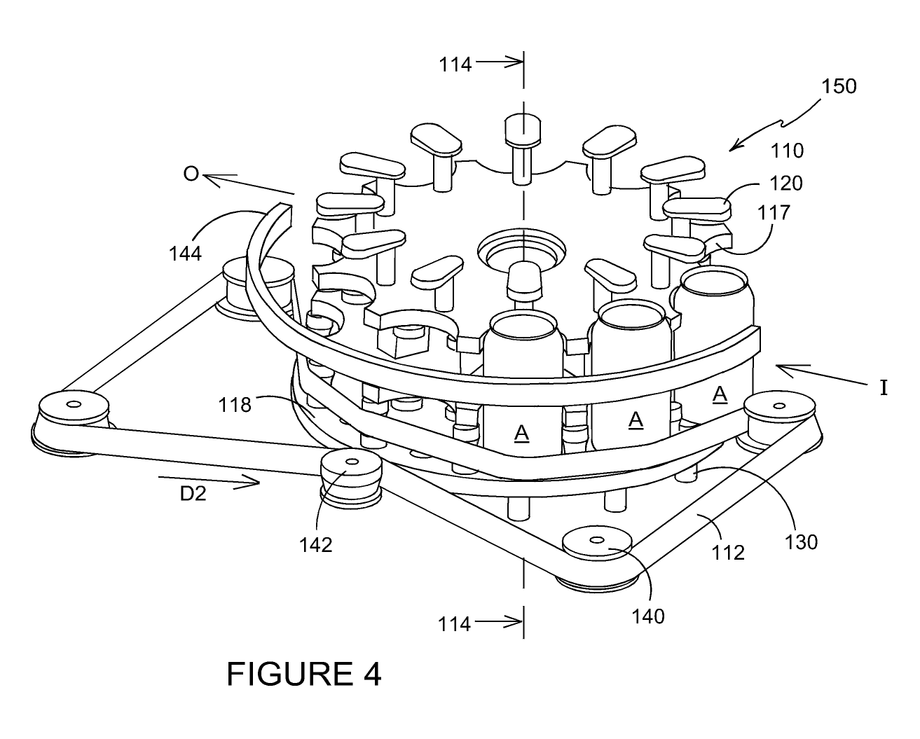

A stream of randomly orientated articles A are delivered to the input point I of the article orientating device 150 on a conveyor (not shown). Each pocket 117 receives an article A; sensors mounted on the starwheel 110 are coupled to a controller (not shown) and based on a signal transmitted from the sensor to the controller, the controller determines whether the article A is in a desired orientation. If the article A is not in the correct orientation the article A is engaged by the article rotation device 112. The article rotation device 112 frictionally engages with the article A to effect rotation of the article A. The sensor continuously monitors the orientation of the article A, when the controller determines that the article A is correctly orientated the article A is disengaged from the article rotation device 112 and maintained in the desired orientation. A stream of orientated articles A exit the starwheel 110 at the output point O to be further processed by a packaging machine or other processing assemblies (not shown). In one embodiment of the invention it is envisaged that the lifting mechanism described above in relation to FIGS. 1 and 2 could be employed in conjunction with the apparatus of present invention as shown in FIG. 4.

The articles A can be orientated by engaging with the dynamic article rotation device 112, which dynamic article rotation device 112 is driven at a different speed to the speed with which the articles A are conveyed by the starwheel 110. It is envisaged that the dynamic article rotation device 112 could be driven at either a greater or lesser speed than that of the starwheel 110. The relative speed differential between the dynamic article rotation device 112 and the starwheel 110 effects the rotation of the articles A. One advantage of using a dynamic article rotation device 112 is that for any given size starwheel 110 a greater throughput of articles A can be achieved by increasing the speed of rotation of the starwheel 110 without leading to an increase in the rotational speed of the articles A whilst being orientated since the relative speed between the starwheel 110 and the dynamic article rotation device 112 can be controlled. Furthermore doing so maintains the same degree of control over the articles A in order to achieve accurate alignment of the articles orientation. This is achieved by increasing the speed of the dynamic article rotation device 112 such that the relative speed between the starwheel 110 and the dynamic article rotation device 112 remains constant.

In another embodiment greater article throughput can be achieved by increasing the diameter of the starwheel 110 such that more pockets 117 are provided so that a greater number of articles A are processed simultaneously; consequently a larger dynamic article rotation device 112 is required. In yet another embodiment the apparatus could be modified to utilise a larger number of pockets 117 simultaneously by extending the article rotation device 112 around a larger circumferential portion of the starwheel 110. For example, instead of the article rotation device 112 extending around substantially 180 degrees of the starwheel 110 (the apparatus as shown in FIG. 3 has been optimized for a straight-line packaging machine), the article rotation device could extend around substantially 270 degrees of the starwheel 110 such that the input stream I and the output stream O are disposed in a substantially perpendicular relationship to one another. In yet a further alternative embodiment the article rotation device 112 could extend almost 360 degrees about the starwheel 110 such that the infeed stream I of articles A and output steam O of articles A are substantially parallel and adjacent one another.

FIG. 4 illustrates the article orientating device 150 in which it can be seen that the dynamic article rotation device 112 is mounted at an elevation with respect to the starwheel 110 such that the dynamic article rotation device 112 engages the articles A at a lower portion thereof. Starwheel 110 is rotatably mounted for rotation about the central axis 114. A fixed guide 144 is provided to support an upper portion of the articles A and to maintain them in cooperative engagement with the starwheel 110 especially when the articles A are disengaged from the dynamic article rotation device 112. Articles A are received in pockets 117 upon a baseplate 118. Lifting devices 130 are provided mounted in baseplate 118 in each respective pocket 117. It is envisaged that lifting devices 130 could be pistons operated pneumatically or hydraulically or by other suitable means. The lifting devices 130 are provided to disengage the articles A from the dynamic article rotation device 112 by raising the articles upwardly, best illustrated in FIGS. 6a and 6b. An end stop 120 is provided with each respective pocket 117 to prevent the lifting device 130 from pushing the articles A out of the pockets 117 and in combination with the lifting device grips the articles A in the desired orientation. Preferably, the dynamic article rotation device 112 comprises a belt mounted upon pulley wheels 140 at least one of which is coupled to a drive means (not shown) such as a servo motor; an idler wheel 142 is provided to maintain the desired tension of the belt.

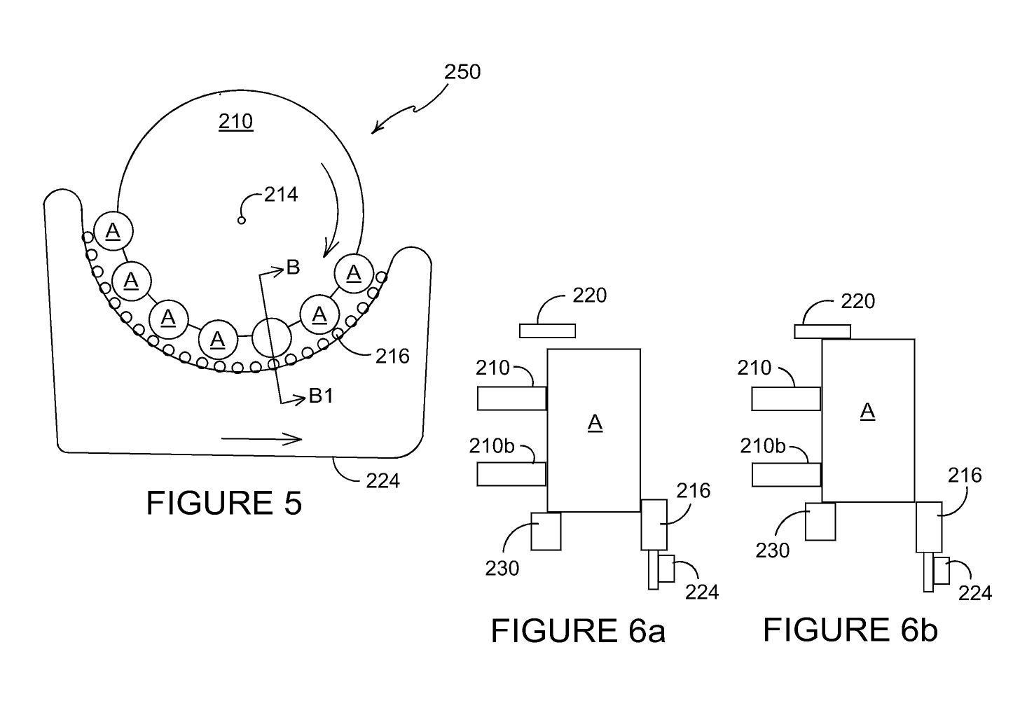

Referring now to FIGS. 5 to 8b, alternative embodiments of the present invention are illustrated in which like numerals have, where possible, been used for like parts, with the addition of the prefix “2” and “3” and therefore only the differences from the embodiment illustrated in FIGS. 1 to 4 will be described in any greater detail.

FIG. 5 illustrates an alternative embodiment of the invention in which the articles A are engaged by a dynamic article rotation device 212 which comprises a plurality of rollers 216 which are driven by a belt 224. The rollers 216 are positioned about the starwheel 210 to be concentric with the starwheel 210 around a portion of the circumference of the starwheel 210. Again belt 224 is mounted upon pulley wheels (not shown) at least one of which is coupled to a drive mechanism (not shown).

FIG. 6a illustrates a cross section taken through line BB', an article A is received in the pocket 217 formed in the starwheel 210, 210b. The lifting device 230 is in a retracted position such that an article A is in frictional engagement with the roller 216.

The roller 216 can then rotate the article A. As the starwheel 210, 210b rotates about axis 214 each article A passes from one roller 216 to the next; each roller 216 that an article A engages with effects rotation of the that article A until such time as it is disengaged from the dynamic article rotation device 212 as described below.

FIG. 6b illustrates a cross section taken through line BB′ in a second mode of operation, a lifting device 230 is in an extended or raised position; the lifting device 230 has raised the article A so as to disengage it from the roller 216, in this mode the roller 216 cannot rotate the article A. The article A has been raised up to meet the end stop 220.

One advantage of this embodiment is that accommodating articles A of different diameters can be achieved easily by using interchangeable starwheels 210, 210b whereby maintaining the articles A in contact with the rollers 216.

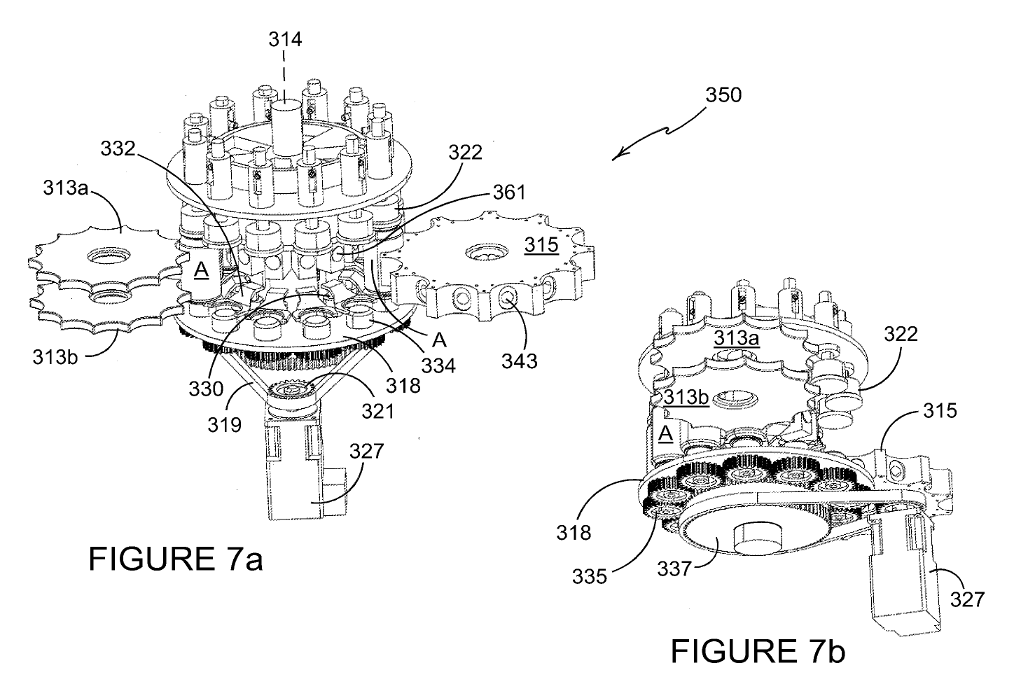

FIG. 7 illustrates a third embodiment of the present invention in which the dynamic article rotation device 312 comprises a plurality of engagement heads 322, each mounted above a respective pocket 317. The each pocket 317 also comprises a plurality of turntables 334. The engagement heads 322 are biased, preferably resiliently biased for example by using a spring mechanism, to clamp the articles A to the turntables 334, alternatively the engagement heads 322 may be coupled to pistons which clamp the articles A against the turntable 334. The turntable 334 are each coupled to a sprocket 335 mounted below the baseplate 318, sprockets 335 are each coupled to central sprocket 337 which is coupled to a drive mechanism 327 via a drive sprocket 321 by a belt 319. When the desired orientation of the cans, as detected by the sensor 361, has been achieved forks 332 raise the articles A away from engagement with the turntables 334. The forks 332 extend at least partially about the turntables 334 and are coupled to a lifting mechanism 330 such as a piston. When the fork 332 disengages the article A from the turntable 334 the engagement head 322 is also raised upwardly against its biasing mechanism.

Optionally, the article orientating device 350 may comprise an input star wheel 313a, 313b and an output starwheel 315. Input starwheel 313a, 313b feeds the articles A into the pockets 317 and output starwheel 315 receives the orientated articles A and conveys them away from the pockets 317. Output starwheel 315 may comprise vacuum cups 343 integrally mounted within receiving pockets of the output starwheel 315 to maintain the correct orientation.

Alternatively, it is envisaged that the engagement heads 322 may be coupled to the drive mechanism 327 in a similar fashion to that described in relation to the turntables 334 above. The engagement heads 322 could then be utilised to rotate the articles A. The articles could be disengaged from the engagement heads 322 for example by lowering the forks 332 and consequently the articles A away from the engagement heads 322.

Optionally, it is envisaged that engagement heads 322 may comprise a vacuum system or other suitable gripping mechanism to engage the articles A.

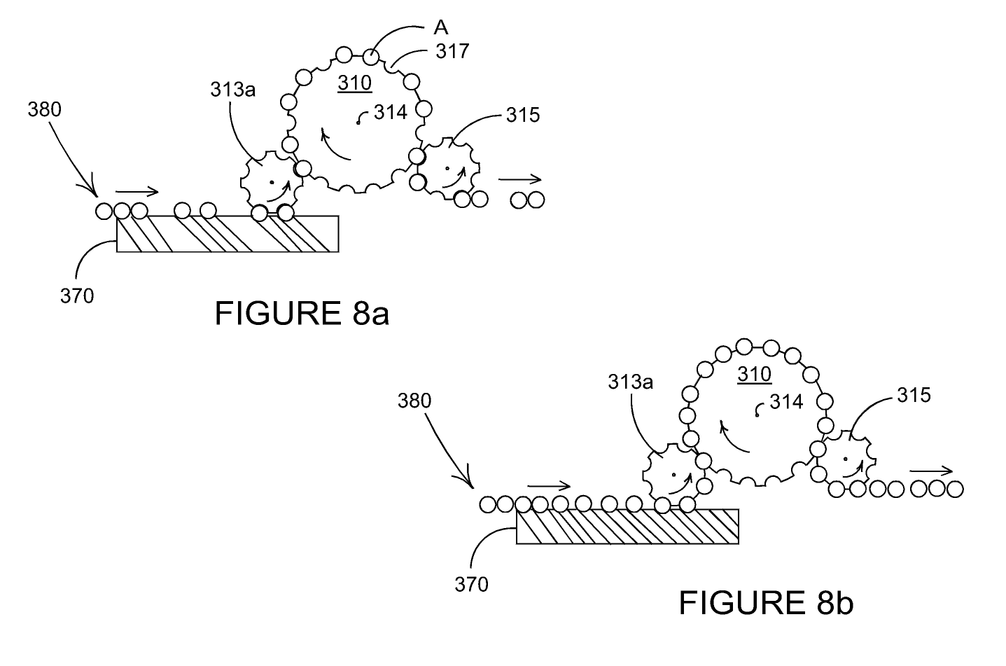

It is also envisaged that the article orientating device 350 may comprise a metering system as illustrated in FIGS. 8a and 8b. A screw mechanism 370 provided at the input end of the article orientating device 350 selects articles from an input stream 380 and feeds articles A either into the input starwheel 313a as shown or directly into the starwheel 310. The pitch of the screw thread selected depends upon the size of the article groups required. It can be seen that when groups of two articles A are desired the every third pocket of the starwheel 310 is left vacant. This may achieved by using a screw thread in which portions of the screw thread are adapted to transfer two articles A as a group and in which intermediate portions do not receive articles A. If groups of three articles are required, as illustrated in FIG. 8b, then all the pockets 317 are filled.

It will be appreciated that various changes may be made within the scope of the present invention, for example, the size and shape of starwheel, article rotation device and/or pockets may be adjusted to accommodate articles of differing size and/or shape. It is also envisaged that the starwheel may be replaced with a linear article transfer device, such as a series of comb elements driven upon a endless conveyor wherein the comb elements comprise pockets for engaging articles and may selectively engage each article with an article rotation device such as and endless belt. It is envisaged that article transfer device would be positioned substantially parallel to the linear transfer device. It is also envisaged that the aforedescribed article orientation device may have application in fields other than packaging.

The simple optical sensor as described above could be replaced with a camera which could be used to determine when the orientation has been achieved this would require a camera for each pocket of the starwheel. The camera could capture an image and a controller could perform a comparison with a predetermined image for calculation of the required rotation or the camera could capture repeated images and the controller could monitor the articles in real time for a predetermined reference image or sequence of images. Alternatively only one camera may be provided at the infeed of the article orientating device, in this embodiment a precise driving system, and more complex, would be required to control the orientation of the articles since it would be necessary to calculate the required rotation of each article and communicate that information to the particular dynamic article rotation device responsible for rotating each respective article and then control the degree of rotation imparted to that article.

In yet another embodiment the article orientating device could employ colour sensors that are able to detect a given sequence of colour changes. Use of colour sensors would allow the simple rotation mechanism described herein to be employed and allow the article orientating device to be adapted to handle articles of various shapes and designs.

1. Apparatus for orientating articles comprising a transfer mechanism for transferring articles at a first speed, at least one sensor for determining the orientation of an article being transferred, an article orientation mechanism moveable at a second speed different from said first speed and an engagement mechanism operable to selectively engage an article with the article orientation mechanism when a desired orientation of the article has been achieved.

2. The apparatus of claim 1 comprising a single drive mechanism coupled to the article orientation mechanism.

3. The apparatus of either one of claim 1 or 2 comprising a controller which sends a signal to the engagement mechanism in response to information collected by the sensor to disengage the article orientation mechanism from the article whereby resulting in said desired orientation of the article.

4. The apparatus of either one of claim 1 or 2 comprising a controller which sends a signal to the article orientation mechanism instructing the article orientation mechanism to impart to the article a predetermined rotation calculated from the information collected by the sensor whereby resulting in said desired orientation of the article.

5. The apparatus of any one of claims 1 to 2 wherein the sensor comprises a colour sensor for detecting a predetermined sequence of colours.

6. The apparatus of any one of claims 1 to 2 wherein the article orientation mechanism comprises an endless belt.

7. The apparatus of any one of claims 1 to 2 wherein the article orientation mechanism comprises a rotator for receiving each article.

8. The apparatus of any one of claims 1 to 2 wherein the engagement mechanism comprises a lifting mechanism for lifting an article, so as to disengage the article from the article orientation mechanism.

9. The apparatus of any one of claims 1 to 2 wherein the transfer mechanism comprises a starwheel having pockets for receiving an article, said starwheel being rotatably mounted about a central axis.

10. The apparatus of claim 1 comprising a drive mechanism coupled to the transfer mechanism.

11. A packaging machine comprising an article orientation device according to claim 1.

12. A method of orientating articles comprising receiving articles in a transfer mechanism, detecting an incorrectly orientated article, engaging said incorrectly orientated article with an article orientation mechanism, moving the article until it is correctly orientated, disengaging the article orientation mechanism from the article, wherein said article orientation mechanism is moveable at a speed relative to the transfer mechanism.

13. The method of claim 12 wherein the articles are orientated whilst being transferred by the transfer mechanism.
